(19) United States
(12) Patent Application Publication
(10) Pub. No.: US 2008/0294982 A1
(43) Pub. Date: Nov. 27, 2008

(54) PROVIDING RELEVANT TEXT AUTO-COMPLETIONS

(75) Inventors: Brian Leung, Foster City, CA (US); Qi Zhang, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/751,121

(22) Filed: May 21, 2007

(51) Int. Cl. G06F 17/21; G06F 17/24

(52) U.S. Cl. 715/261

(57) ABSTRACT

A processing device, such as, for example, a tablet PC, or other processing device, may receive non-textual language input. The non-textual language input may be recognized to produce one or more textual characters. The processing device may generate a list including one or more prefixes based on the produced one or more textual characters. Multiple text auto-completion predictions may be generated based on multiple prediction data sources and the one or more prefixes. The multiple text auto-completion predictions may be ranked and sorted based on features associated with each of the text auto-completion predictions. The processing device may present a predetermined number of best text auto-completion predictions. A selection of one of the presented predetermined number of best text auto completion predictions may result in a word, currently being entered, being replaced by the selected one of the predetermined number of best text auto completion predictions.

### BACKGROUND

Many input systems for processing devices, such as, for example, a tablet personal computer (PC), or other processing device, provide text prediction capabilities to streamline a text inputting process. For example, in existing text prediction implementations, as a word is being entered, one character at a time, only words that are continuations of a current word being entered may be presented to a user as text predictions. If the user sees a correct word, the user may select the word to complete inputting of the word.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a processing device may receive language input. The language input may be non-textual input such as, for example, digital ink input, speech input, or other input. The processing device may recognize the language input and may produce one or more textual characters. The processing device may then generate a list of one or more prefixes based on the produced one or more textual characters. For digital ink input, alternative recognitions may be included in the list of one or more prefixes. Multiple text auto-completion predictions may be generated from multiple prediction data sources based on the generated list of one or more prefixes. Feature vectors describing a number of features of each of the text auto-completion predictions may be generated. The text auto-completion predictions may be ranked and sorted based on respective feature vectors. The processing device may present a predetermined number of best text auto-completion predictions. A selection of one of the presented predetermined number of best text auto-completion predictions may result in a word, currently being entered, being replaced with the selected one of the presented predetermined number of best text auto-completion predictions.

In some embodiments, one or more prediction data sources may be generated based on user data. In such embodiments, the text auto-completion predictions may be generated based, at least partly, on the user data.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram illustrating an exemplary processing device, which may be used to implement embodiments consistent with the subject matter of this disclosure.

FIGS. 2A-2B illustrate a portion of an exemplary display of a processing device in an embodiment consistent with the subject matter of this disclosure.

FIG. 3 is a flow diagram illustrating exemplary processing that may be performed when training a processing device to generate relevant possible text auto-completion predictions.

FIG. 4 is a flowchart illustrating an exemplary process for recognizing non-textual input, generating text auto completion predictions, and presenting a predetermined number of text auto-completion predictions.

FIG. 5 is a block diagram illustrating an exposed recognition prediction application program interface and an exposed recognition prediction result application program interface, which may include routines or procedures callable by an application.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, a processing device may be provided. The processing device may receive language input from a user. The language input may be text, digital ink, speech, or other language input. In one embodiment, non-textual language input, such as, for example, digital ink, speech, or other non-textual language input, may be recognized to produce one or more textual characters. The processing device may generate a list of one or more prefixes based on the input text or the produced one or more textual characters. For digital ink input, alternate recognitions may be included in the list of one or more prefixes. The processing device may generate multiple text auto-completion predictions from multiple prediction data sources based on the generated list of one or more prefixes. The processing device may sort the multiple text auto-completion predictions based on features associated with each of the auto-completion predictions. The processing device may present a predetermined number of best text auto-completion predictions as possible text auto-completion predictions. Selection of one of the presented predetermined number of best text auto-completion predictions may result in a currently entered word being replaced with the selected one of the presented predetermined number of best text auto-completion predictions.

In one embodiment consistent with the subject matter of this disclosure, the multiple prediction data sources may include a lexicon-based prediction data source, an input-history prediction data source, a personalized lexicon prediction data source, and an ngram language model prediction data source. The lexicon-based prediction data source may be a generic language data source in a particular language, such as, for example, English, Chinese, or another language. The input-history prediction data source may be based on text included in newly-created or newly-modified user documents, such as email, textual documents, or other documents, as well as other input, including, but not limited to digital ink, speech input, or other input. With respect to the input-history prediction data source, the processing device may keep track of most recent words that have been entered, how recently the words have been entered, what words are inputted after other words, and how often the words have been entered. The personalized lexicon prediction data source may be a user lexicon based on user data, such as, for example, text included in user documents, such as email, textual documents, or other documents. With respect to the personalized lexicon prediction data source, the processing device may keep track of most or all words that have been entered, and what words are inputted after other words. In some embodiments, language model information, such as, for example, word frequency or other information may be maintained. The n-gram language model prediction data source may be a generic language data source, or may be built (or modified/updated) by analyzing user data (e.g. user documents, email, textual document) and producing an ngram language model including information with respect to groupings of words and letters from the prediction data sources.

### Exemplary Processing Device

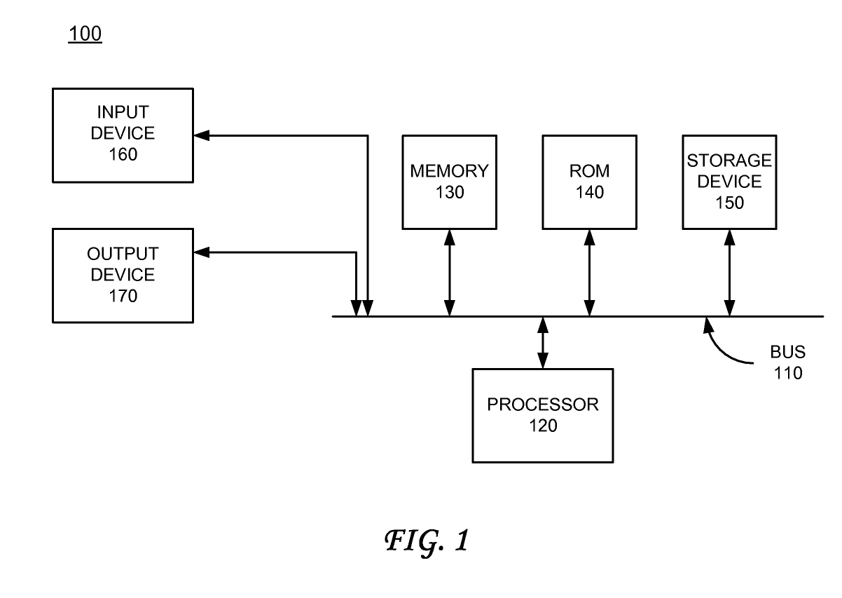

FIG. 1 is a functional block diagram that illustrates an exemplary processing device 100, which may be used to implement embodiments consistent with the subject matter of this disclosure. Processing device 100 may include a bus 110, a processor 120, a memory 130, a read only memory (ROM) 140, a storage device 150, an input device 160, and an output device 170. Bus 110 may permit communication among components of processing device 100.

Processor 120 may include at least one conventional processor or microprocessor that interprets and executes instructions. Memory 130 may be a random access memory (RAM) or another type of dynamic storage device that stores information and instructions for execution by processor 120. In one embodiment, memory 130 may include a flash RAM device. Memory 130 may also store temporary variables or other intermediate information used during execution of instructions by processor 120. ROM 140 may include a conventional ROM device or another type of static storage device that stores static information and instructions for processor 120. Storage device 150 may include any type of media for storing data and/or instructions.

Input device 160 may include a display or a touch screen, which may further include a digitizer, for receiving input from a writing device, such as, for example, an electronic or non-electronic pen, a stylus, a user's finger, or other writing device. In one embodiment, the writing device may include a pointing device, such as, for example, a computer mouse, or other pointing device. Output device 170 may include one or more conventional mechanisms that output information to the user, including one or more displays, or other output devices.

Processing device 100 may perform such functions in response to processor 120 executing sequences of instructions contained in a tangible machine-readable medium, such as, for example, memory 130, or other medium. Such instructions may be read into memory 130 from another machine-readable medium, such as storage device 150, or from a separate device via communication interface (not shown).

### EXAMPLES

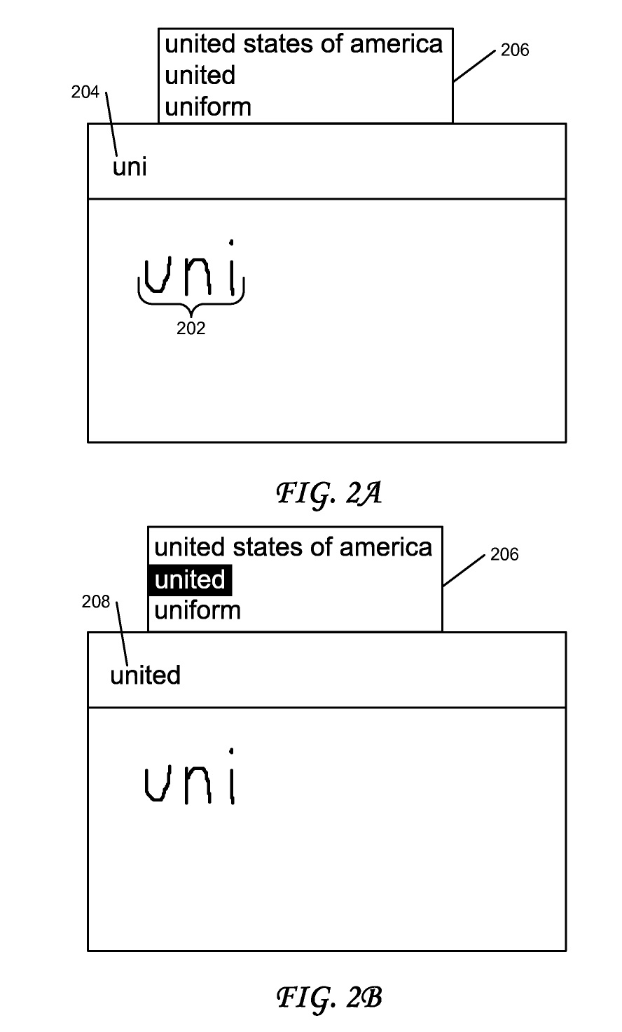

FIG. 2A illustrates a portion of an exemplary display of a processing device in one embodiment consistent with the subject matter of this disclosure. A user may enter language input, such as, for example, strokes of a digital ink 202, with a writing device. The strokes of digital ink may form letters, which may form one or more words. In this example, digital ink 202 may form letters “uni”. A recognizer, such as, for example, a digital ink recognizer, may recognize digital ink 202 and may present a recognition result 204. The recognizer may produce multiple possible recognition results via a number of recognition paths, but only a best recognition result from a most likely recognition path may be presented or displayed as recognition result 204.

The processing device may generate a list including at least one prefix based on the multiple possible recognition results. For example, the processing device may generate a list including a prefix of “uni”. The processing device may refer to multiple prediction data sources looking for words beginning with the prefix. The processing device may produce many possible text auto-completion predictions from the multiple prediction data sources. In some embodiments, hundreds or thousands of possible text auto-completion predictions may be produced.

The processing device may generate a feature vector for each of the possible text auto-completion predictions. Each of the feature vectors may describe a number of features of each of the possible text auto-completion predictions. Exemplary feature vectors are described in more detail below. The possible text auto-completion predictions may be compared to one another to rank or sort the possible text auto-completion predictions. The processing device may present a predetermined number of most relevant possible text auto-completion predictions 206. In one embodiment, three most relevant possible text auto-completion predictions may be presented, as shown in FIGS. 2A and 2B. In other embodiments, the processing device may present a different number of most relevant possible text auto-completion predictions. In FIG. 2A, most relevant possible text auto-completion predictions 206 include, “united states of america”, “united”, and “uniform”. Thus, each of the possible text auto-completion predictions may include one or more words.

The user may select one of the predetermined number of most relevant possible text auto-completion predictions 206 with a pointing device or a writing device. For example, the user may use a computer mouse to select one of the predetermined number of most relevant possible text auto-completion predictions 206 by clicking on one of possible text auto-completion predictions 206, or the user may simply touch a portion of a display screen displaying a desired one of the possible text auto-completion predictions 206 with a writing device. In other embodiments, the user may select one of the predetermined number of most relevant possible text auto-completion predictions 206 via a different method. In this example, the user selected the word, “united”. The processing device may highlight the selected possible text auto-completion prediction, as shown in FIG. 2B. After selecting one of the predetermined number of most relevant possible text auto-completion predictions 206, presented recognition result 204 may be replaced by the selected text auto-completion prediction, which may further be provided as input to an application, such as, for example, a text processing application, or other application.

### Training

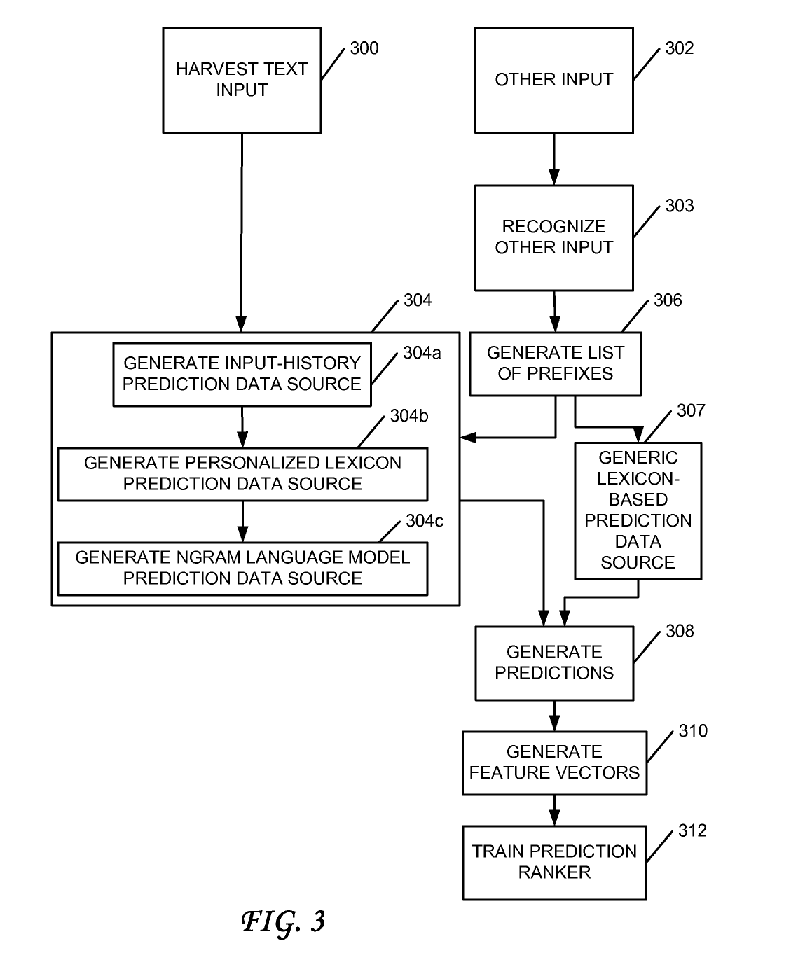

FIG. 3 illustrates exemplary processing that may be performed when training the processing device to generate relevant possible text auto-completion predictions. In one embodiment, the processing device may harvest a user's text input, such as, for example, sent and/or received e-mail messages, stored textual documents, or other text input (act 300). The processing device may then generate a number of personalized auto-completion prediction data sources (act 304).

For example, the processing device may generate an input-history prediction data source (act 304a). In one embodiment, only words and groupings of words from recent user text input may be included in input-history prediction data source. The processing device may generate a personalized lexicon prediction data source (act 304b). In one embodiment, personalized lexicon prediction data source may include words and groupings of words from harvested user text input regardless of how recently the text input was entered. The processing device may also generate an ngram language model prediction data source (act 304c), which may include groupings of letters or words from the above-mentioned prediction data sources, as well as any other prediction data sources. In some embodiments, the processing device may include a generic lexicon-based prediction data source 307, which may be a generic prediction data source with respect to a particular language, such as, for example, English, Chinese, or another language. In other embodiments, a domain lexicon prediction data source in the particular language may be included. For example, a medical domain prediction data source, a legal domain prediction data source, a domain lexicon prediction data source built based upon search query logs, or another prediction data source may be included. In some embodiments, the domain lexicon prediction data source may be provided instead of the generic lexicon-based prediction data source. In other embodiments, the domain lexicon prediction data source may be provided in addition to the generic lexicon-based prediction data source.

The processing device may also receive or process other input, such as textual input or non-textual input (act 302). Non-textual input may be recognized to produce one or more characters of text (act 303).

After generating the personalized auto-completion prediction data sources, the processing device may process the other input one character at a time or one word at a time, as if the input is currently being entered by a user. As the input is being processed one character at a time or one word at a time, the processing device may generate a list of one or more prefixes based on the input (act 306). The prefixes may include one or more letters, one or more words, or one or more words followed by a partial word. If the input is non-textual input, the processing device may produce the list of prefixes based, at least partly, on recognition results from a predetermined number of recognition paths having a highest likelihood of being correct. In one embodiment, the processing device may produce the list of prefixes based, at least partly, on recognition results from three of the recognition paths having a highest likelihood of being correct. In other embodiments, the processing device may produce the list of prefixes based, at least partly, on recognition results from a different number of recognition paths having a highest likelihood of being correct.

The processing device may then generate a number of text auto-completion predictions based on respective prefixes and the multiple prediction data sources, such as, for example, the generic lexicon-based prediction data source, the input-history prediction data source, the personalized lexicon prediction data source, and the ngram language model prediction data source (act 308). In other embodiments, the processing device may generate text auto-completions based on additional, different or other data sources. In some embodiments, in order to keep a number of predictions to a manageable number, all predictions based on a prefix from a top recognition path having a highest likelihood of being correct may be kept and most frequent ones of the text auto-completion predictions based on other prefixes may be kept.

The processing device may then generate respective feature vectors for the kept text auto-completion predictions (act 310). In one embodiment, each of the feature vectors may include information describing:
a length of a prefix used to generate a text auto-completion prediction;
placement of each character in the prefix that generated the text auto-completion prediction (i.e., from which recognition path each character in the prefix was obtained);
recognition scores for each character in the prefix;
a length of the text auto-completion prediction;
whether the prefix is a word;
a unigram formed by the prefix and the text auto-completion prediction;
a bigram formed by the prefix and the text auto-completion prediction with a preceding word;
a character unigram of a first character in the text auto-completion prediction; and
a character a bigram of a last character in the prefix and a first character in the text auto-completion prediction.
   In other embodiments, the feature vectors may include additional information, or different information.

Next, a prediction ranker may be trained (act 312). The prediction ranker may include a comparative neural network or other component which may be trained to determine which text auto completion prediction is more relevant than another text auto completion prediction. During training, actual input is known. Therefore, whether a particular text auto-completion prediction is correct or not is known. Pairs of text auto-completion predictions may be added to a training set. For example, if a first text auto-completion prediction matches the actual input and a second text auto-completion prediction does not match the actual input, then a data point may be added to the training set with a label indicating that the matching text auto-completion prediction should be ranked higher than the non-matching text auto-completion prediction. Pairs of text auto-completion predictions including two text auto-completion predictions matching the actual input, or two text auto-completion predictions not matching the actual input may not be added to the training set. The prediction ranker may be trained based on the pairs of text auto-completion predictions and corresponding labels added to the training set. In some embodiments, the prediction ranker may be trained to favor longer predictions.

### Exemplary Processing During Operation

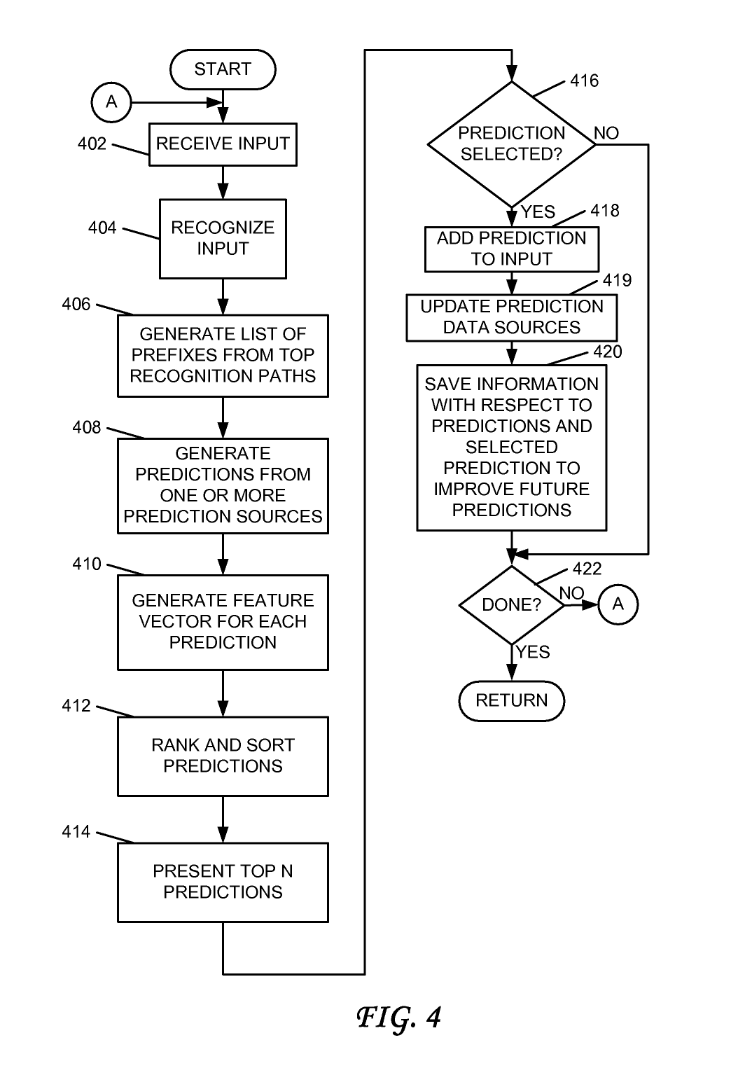

FIG. 4 is a flowchart illustrating an exemplary process, which may be performed by a processing device consistent with the subject matter of this disclosure. The process may begin with the processing device receiving input (act 402). The input may be non-textual input, such as, for example, digital ink input, speech input, or other input. With respect to the exemplary process of FIG. 4, we assume that the input is digital ink input.

The processing device may then recognize the input to produce at least one textual character (act 404). During recognition, one or more textual characters may be produced with respect to multiple recognition paths. Each of the recognition paths may have a corresponding likelihood of producing a correct recognition result. The processing device may generate a list of prefixes based on information from a predetermined number of recognition paths having a highest likelihood of producing a correct recognition result (act 406). In one embodiment, the processing device may produce the list of prefixes based, at least partly, on recognition results from three of the recognition paths having a highest likelihood of being correct. In other embodiments, the processing device may produce prefixes based, at least partly, on recognition results from a different number of recognition paths having a highest likelihood of being correct.

The processing device may then generate a number of text auto-completion predictions based on respective prefixes and one or more prediction data sources (act 408). The processing device may generate the text auto-completion predictions by finding a respective grouping of characters, which matches ones of the respective prefixes, in the multiple prediction data sources. In one embodiment, the multiple prediction data sources may include the generic lexicon-based prediction data source, the input-history prediction data source, the personalization lexicon prediction data source, and the ngram language model prediction data source, as discussed with respect to training and FIG. 3. In other embodiments, the processing device may generate text auto-completion predictions based on additional, different or other data sources. In some embodiments, in order to keep a number of text auto-completion predictions to a manageable number, all predictions based on a prefix from a top recognition path having a highest likelihood of being correct may be kept and most frequent ones of the text auto-completion predictions based on other prefixes may be kept.

The processing device may then generate respective feature vectors for the kept text auto-completion predictions (act 410). In one embodiment, each of the feature vectors may include information as described previously with respect to act 310. In other embodiments, each of the feature vectors may include additional information, or different information. Next, the trained prediction ranker may rank and sort the kept text auto-completion predictions based on corresponding ones of the feature vectors (act 412). In one embodiment, the trained prediction ranker may rank and sort the kept auto-completion predictions by using a comparator neural network to compare feature vectors and a merge-sort technique. In another embodiment, the trained prediction ranker may rank and sort the kept auto-completion predictions by using a comparator neural network to compare feature vectors and a bubble sort technique. In other embodiments other sorting techniques may be used to rank and sort the kept auto-completion predictions.

After the prediction ranker ranks and sorts the text auto-completion predictions, the processing device may present or display a predetermined number of best text auto-completion predictions (act 414). In some embodiments, the predetermined number of best text auto-completion predictions may be the predetermined number of text auto-completion predictions in top positions of ranked and sorted text auto-completion predictions. In one embodiment, the predetermined number of best text auto-completion predictions may be three of the best text auto-completion predictions of the ranked and sorted text auto-completion predictions.

The processing device may then determine whether the user selected any of the predetermined number of best text auto-completion predictions (act 416). In one embodiment, the user may select one of the predetermined number of best text auto-completion predictions in a manner as described with respect to FIGS. 2A and 2B. If the user continues to provide input, such as, for example, digital ink input, speech input, or other input to be converted to text, then the processing device may determine that the user is not selecting one of the predetermined number of best text auto-completion predictions.

If the user selects one of the presented predetermined number of best text auto-completion predictions, then the processing device may complete input being entered by the user by replacing a currently entered word or partial word with the selected one of the presented predetermined number of best text auto-completion predictions (act 418). The processing device may then update prediction data sources (act 419). For example, the processing device may update the input-history prediction data source, the personalized lexicon prediction data source, the ngram language model prediction data source, or other or different prediction data sources.

Next, the processing device may save information with respect to prefixes, text auto-completion predictions, text auto-completion predictions selected, and/or other information for further training of the prediction ranker to increase accuracy of the presented predetermined number of best text auto-completion predictions (act 420). For example, a prefix, a selected one of the presented best text auto-completion predictions, and an unselected one of the presented best text auto-completion predictions, respective feature vectors, and a label indicating which text auto-completion prediction is a correct text auto-completion prediction may be saved in a training set for further training of the prediction ranker.

The processing device may then determine whether the process is complete (act 422). In some embodiments, the processing device may determine that the process is complete when the user provides an indication that an inputting process is complete by exiting an inputting application, or by providing another indication.

### Application Program Interface

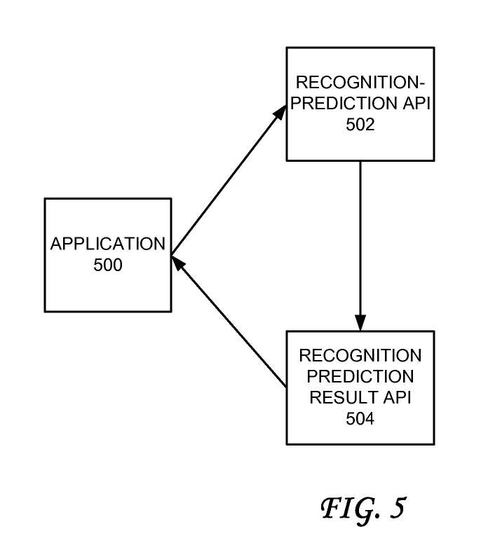

An application program interface (API) for providing text auto-completion predictions may be exposed in some embodiments consistent with the subject matter of this disclosure, such that an application may set recognition parameters and may receive text auto-completion predictions. FIG. 5 is a block diagram illustrating an application 500 using exposed recognition prediction API 502 and exposed recognition prediction result API 504.

In one embodiment consistent with the subject matter of this disclosure, recognition prediction API 502 may include exposed routines, such as, for example, Init, GetRecoPredictionResults, SetRecoContext, and SetTextContext. Init may be called by application 500 to initialize various recognizer settings for a digital ink recognizer, a speech recognizer, or other recognizer, and to initialize various predictions settings, such as, for example, settings with respect to feature vectors, or other settings. SetTextContext may be called by application 500 to indicate that input will be provided as text. SetRecoContext may be called by application 500 to indicate that input will be provided as digital ink input, speech input, or other non-textual input. As a result of SetRecoContext being called, the processing device may obtain alternate recognitions from a recognizer, such as, for example, a digital ink recognizer, a speech recognizer, or other recognizer, based on the non-textual input. The alternate recognitions may be used as prefixes for generating text auto-completion predictions. GetRecoPredictionResults may be called by application 500 to obtain text auto-completion predictions and store the text auto-completion prediction in an area indicated by a parameter provided when calling GetRecoPredictionResults.

Recognition prediction result API 504 may include exposed routines, such as, for example, GetCount, GetPrediction, and GetPrefix. Application 500 may call GetCount to obtain a count of text auto-completion predictions stored in an indicated area as a result of a previous call to GetRecoPredictionResults. Application 500 may call GetPrediction to obtain one text auto-completion prediction at a time stored in the indicated area as a result of a call to GetRecoPredictionResults. Application 500 may call GetPrefix to obtain a prefix used to generate a text auto-completion prediction obtained by calling GetPrediction.

The above-described API is an exemplary API. In other embodiments, exposed routines of the API may include additional routines, or other routines.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A machine-implemented method for providing text auto-completion predictions with respect to language input, the machine-implemented method comprising:
recognizing the language input and producing at least one textual character;
generating a list including at least one prefix based on the at least one textual character;
generating a plurality of text auto-completion predictions from a plurality of prediction sources based on the generated list;
sorting the plurality of text auto-completion predictions based on a plurality of features associated with each of the plurality of text auto-completion predictions; and
presenting a predetermined number of best text auto-completion predictions as possible text auto-completion predictions with respect to the language input.

2. The machine-implemented method of claim 1, wherein:
the language input is one of handwritten digital ink or speech.

3. The machine-implemented method of claim 1, wherein:
generating a plurality of text auto-completion predictions from the plurality of prediction sources based on the generated list further comprises:
generating respective feature vectors for each of the plurality of text auto-completion predictions, each of the respective feature vectors describing a plurality of features of corresponding ones of the plurality of text auto-completion predictions; and
sorting the plurality of text auto-completion predictions based on a plurality of features associated with each of the plurality of text auto-completion predictions further comprises:
performing a merge sort of the plurality of text auto-completion predictions based on comparing the respective feature vectors.

4. The machine-implemented method of claim 1, wherein:
generating a list including at least one prefix based on the at least one textual character further comprises:
generating the list based on textual data from a best predetermined number of recognition paths produced by the recognizing of the language input.

5. The machine-implemented method of claim 1, wherein the plurality of prediction data sources include an input history prediction data source built from recently-entered user data, a personalized lexicon prediction data source based on input user data, a domain lexicon prediction data source, and an ngram language model prediction data source based, at least partly, on the user data.

6. The machine-implemented method of claim 1, wherein the plurality of features associated with each of the plurality of text auto-completion predictions comprise:
a length of a prefix used to generate a respective text auto-completion prediction,
a length of the respective text auto-completion prediction,
whether the prefix is a word,
a unigram of the prefix and the respective text auto-completion prediction,
a bigram of the prefix, the respective text auto-completion prediction, and a word preceding the respective text auto-completion prediction,
a character unigram of a first character of the respective text auto-completion prediction, and
a character bigram of a last character in the prefix and the first character in the respective text auto-completion prediction.

7. The machine-implemented method of claim 1, further comprising:
exposing an application program interface for applications to request and receive text auto-completion prediction related data.

8. A tangible machine-readable medium having instructions recorded thereon for at least one processor of a processing device, the instructions comprising:
instructions for building and updating a plurality of prediction data sources based, at least in part, on user data,
instructions for recognizing user language input and producing a list including a plurality of prefixes based on a predetermined number of best recognition paths,
instructions for generating a plurality of text-auto completion predictions from the plurality of prediction data sources based on the plurality of prefixes,
instructions for generating a respective feature vector for each of the plurality of text auto-completion predictions, each of the respective feature vectors describing a plurality of features with respect to a corresponding one of the plurality of text auto-completion predictions,
instructions for ranking the plurality of text auto-completion predictions based on the respective feature vectors, and
instructions for presenting a predetermined number of best ones of the plurality of text auto-completion predictions as possible text auto-completions to the user language input.

9. The tangible machine-readable medium of claim 8, further comprising:
instructions for limiting a number of the plurality of predictions to consider by keeping ones of the plurality of text auto-completion predictions based on one of the plurality of prefixes from a best recognition path, and keeping most frequently predicted ones of the plurality of text auto-completion predictions based on ones of the plurality of prefixes other than the one of the plurality of prefixes from the best recognition path.

10. The tangible machine-readable medium of claim 8, wherein the user language input is handwritten digital ink.

11. The tangible machine-readable medium of claim 8, wherein the instructions for building and updating a plurality of prediction data sources based, at least in part, on user data comprise:
instructions for building an input-history prediction data source based on recent user data input,
instructions for building a personalized lexicon prediction data source based on stored user data, and
instructions for building an ngram language model based, at least in part, on the stored user data.

12. The tangible machine-readable medium of claim 8, wherein the instructions for generating a plurality of text auto-completion predictions from the plurality of prediction data sources based on the plurality of prefixes further comprise:
instructions for finding a respective grouping of characters in the plurality of prediction data sources that matches ones of the plurality of prefixes and generating a respective text auto-completion prediction based on one or more characters associated with the respective grouping of characters.

13. The tangible machine-readable medium of claim 8, wherein at least some of the plurality of text auto-completion predictions include at least one word following a current word of the user language input being entered.

14. The tangible machine-readable medium of claim 8, wherein the instructions for ranking the plurality of text auto-completion predictions based on the respective feature vectors comprise:
instructions for favoring longer predictions over shorter predictions.

15. The tangible machine-readable medium of claim 8, wherein the instructions further comprise:
instructions for exposing an application program interface to provide at least one text auto-completion prediction with respect to a result of recognizing user input language.

16. A processing device comprising:
at least one processor;
a memory;
a bus connecting the at least one processor with the memory, the memory comprising:
instructions for recognizing digital ink input, representing language input, to produce a recognition result,
instructions for generating a plurality of text auto-completion predictions based on the recognition result, at least some of the plurality of text auto-completion predictions predicting words following a current word being entered,
instructions for presenting up to a predetermined number of best ones of the plurality of text auto-completion predictions,
instructions for receiving a selection of one of the presented predetermined number of best ones of the plurality of text auto-completion predictions, and
instructions for providing the selected one of the presented predetermined number of best ones of the plurality of text auto-completion predictions as input.

17. The processing device of claim 16, wherein the instructions for generating a plurality of text auto-completion predictions based on the recognition result further comprise:
instructions for generating the plurality of text auto-completion predictions from a plurality of prediction data sources, at least some of the plurality of data sources being derived from stored user data.

18. The processing device of claim 16, wherein the instructions for generating a plurality of text auto-completion predictions based on the recognition result further comprise:
instructions for generating the plurality of predictions from a plurality of prediction data sources, at least some of the plurality of prediction data sources being derived from stored user data, and one of the plurality of prediction data sources being a generic lexicon-based prediction data source for a particular language or a domain lexicon prediction data source.

19. The processing device of claim 16, wherein the memory further comprises instructions for ranking the plurality of text auto-completion predictions according to a plurality of features associated with each of the plurality of text auto-completion predictions and a prefix based on the recognition result, a relevance of each of the plurality of features being previously trained based on previously provided text input.

20. The processing device of claim 16, wherein the memory further comprises:
instructions for using a comparative neural network to rank the plurality of text auto-completion predictions according to a plurality of features associated with each of the plurality of text auto-completion predictions and a prefix based on the recognition result.
